(19) United States
(12) Patent Application Publication
(10) Pub. No.: US 2007/0120310 A1
(43) Pub. Date: May 31, 2007

(54) Sheet treatment apparatus

(75) Inventor: Hiroaki Awano, Ebina (JP)

Correspondence Address: MORGAN LEWIS & BOCKIUS LLP, 1111 PENNSYLVANIA AVENUE NW, WASHINGTON, DC, 20004, US

(73) Assignee: Fuji Xerox Co., Ltd.

(21) Appl. No.: 11/472,474

(22) Filed: Jun. 22, 2006

(30) Foreign Application Priority Data
Nov. 25, 2005 (JP) 2005-339790

(51) Int. Cl. B42C 1/00

(52) U.S. Cl. 270/45

(57) ABSTRACT

A sheet treatment apparatus has an image forming unit that forms images on a plurality of sheets, a booklet producing unit that produces a booklet by laying the plurality of sheets on top of one another and folding the plurality of sheets, the folded back of the booklet being pressed to flatten a spine of the booklet, and a control unit that controls the image forming unit to form the image in an image forming area of the sheet, in way that the closer the sheet is located to a booklet cover side, the farther an edge of the image forming area which is close to a center of a double pages spread is located away from the center of the double pages spread.

This application claims priority under 35 USC 119 from Japanese patent application 2005-339790, the disclosure of which is incorporated by reference herein.

### BACKGROUND

(i) Technical Field

The present invention relates to a sheet treatment apparatus that treats a sheet.

(ii) Related Art

Conventionally, in some of pieces of sheet treatment apparatus typified by a printer and a copying machine, a booklet producing unit is added besides an image forming unit which forms an image on a sheet. The booklet producing unit produces a booklet from sheets on which the images are formed. In the booklet producing unit, the sheets are laid on top of one another and folded in order to produce the booklet, and the sheets which are simply folded have a bulge. Therefore, in some of pieces of sheet treatment apparatus, a square folding process is performed by the booklet producing unit in order to produce the high-quality. During the square folding process, on the sheets in the folded state, a neighborhood of a portion corresponding to a spine of the booklet is clamped by a clamping unit, and the portion corresponding to the back is pressed against a roller. The roller is moved along the portion corresponding to the back to press the portion, which results in the booklet whose back is flattened. In some of pieces of sheet treatment apparatus, the booklet producing unit cuts and aligns edges of the folded sheets. For cutting and aligning the edge, in a piece of apparatus is disclosed a technique of shifting an area where the image is formed on the sheet toward the center side of double spread in order to prevent marginal misalignment caused by cutting and aligning the edges.

### SUMMARY

According to an aspect of the invention, there is provided a sheet treatment apparatus including an image forming unit that forms images in plural sheets; a booklet producing unit that produces a booklet by laying the plural sheets on top of one another and folding the plural sheets, the folded back of the booklet being pressed to flatten a spine of the booklet; a control unit that controls the image forming unit to form the image in an image forming area of the sheet in way that, the closer the sheet is located to a booklet cover side, the farther an edge of the image forming area which is close to a center of a double pages spread is located away from the center of the double pages spread.

### BRIEF DESCRIPTION OF THE DRAWINGS

Embodiments of the present invention will be described in detail based on the following figures, wherein:

FIG. 1 shows an image forming system as a first embodiment of the invention;

FIG. 2 shows an outline of an image forming apparatus of the image forming system shown in FIG. 1;

FIG. 3 shows an outline of a function of a square folding device;

FIG. 4 is a block diagram showing an electric configuration of the image forming system shown in FIG. 1;

FIG. 5 schematically shows a state in which folded sheets are flattened by a square folding device 9;

FIG. 6 is a table showing a forbidden distance on each sheet;

FIG. 7 schematically shows a state in which the folded sheets are flattened by the square folding device 9;

FIG. 8 is a table showing the forbidden distance on each sheet;

FIG. 9 shows an image forming area on a sheet;

FIG. 10 is a flowchart showing image formation and bookbinding process in the image forming system;

FIG. 11 shows an image forming area on a sheet in a second embodiment of the invention;

FIG. 12 shows an image forming area on a sheet in a third embodiment of the invention;

FIG. 13 shows an image forming area on a sheet in a fourth embodiment of the invention;

FIG. 14 schematically shows a state in which the folded sheets are flattened by a square folding device 9 in a fifth embodiment of the invention; and

FIG. 15 is a table showing the forbidden distance on each sheet in the fifth embodiment of the invention.

### DETAILED DESCRIPTION

Exemplary embodiments of the sheet treatment apparatus according to an aspect of the invention will be described below with reference to the drawings.

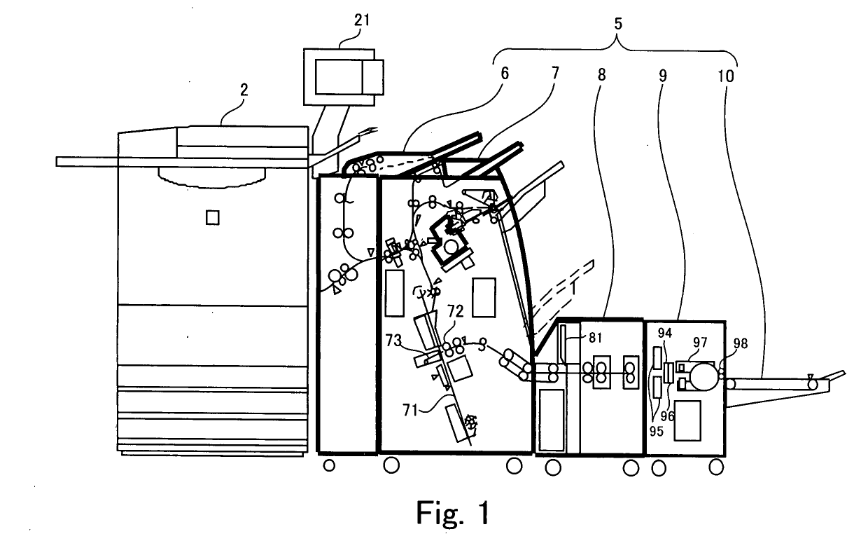

FIG. 1 shows an image forming system as a first embodiment of the invention.

An image forming system 1 includes an image forming apparatus 2 and a post-treatment apparatus 5. The image forming apparatus 2 forms the image on the sheet, and the post-treatment apparatus 5 performs the post-treatment to the sheet on which the image is formed by the image forming apparatus 2.

The image forming apparatus 2 is one that forms the image on the sheet by an electrophotographic method to convey the sheet to the post-treatment apparatus 5. The image forming apparatus 2 includes an operation panel 21 through which a user inputs information.

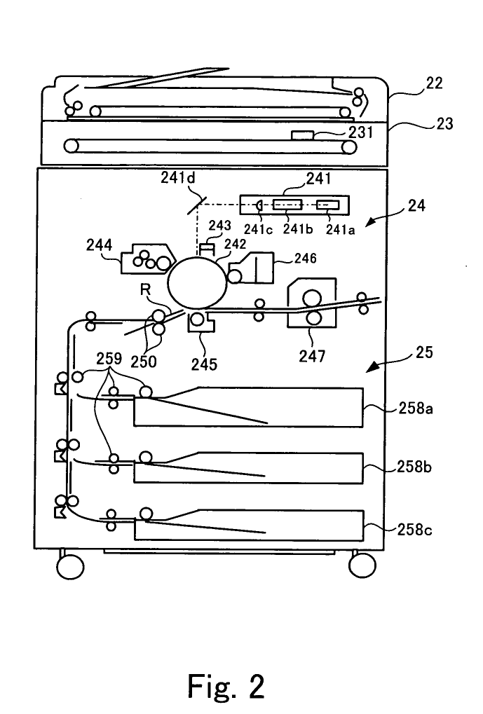

FIG. 2 shows an outline of an image forming apparatus of the image forming system shown in FIG. 1.

The image forming apparatus 2 includes an automatic original supply device 22, an image input device 23, an image output device 24, and a sheet feeder 25.

The automatic original supply device 22 supplies a loaded original to the image input device 23 one by one.

The image input device 23 includes an imaging unit 231. The image input device 23 reads the original supplied from the automatic original supply device 22 and the image input device 23 outputs an image signal.

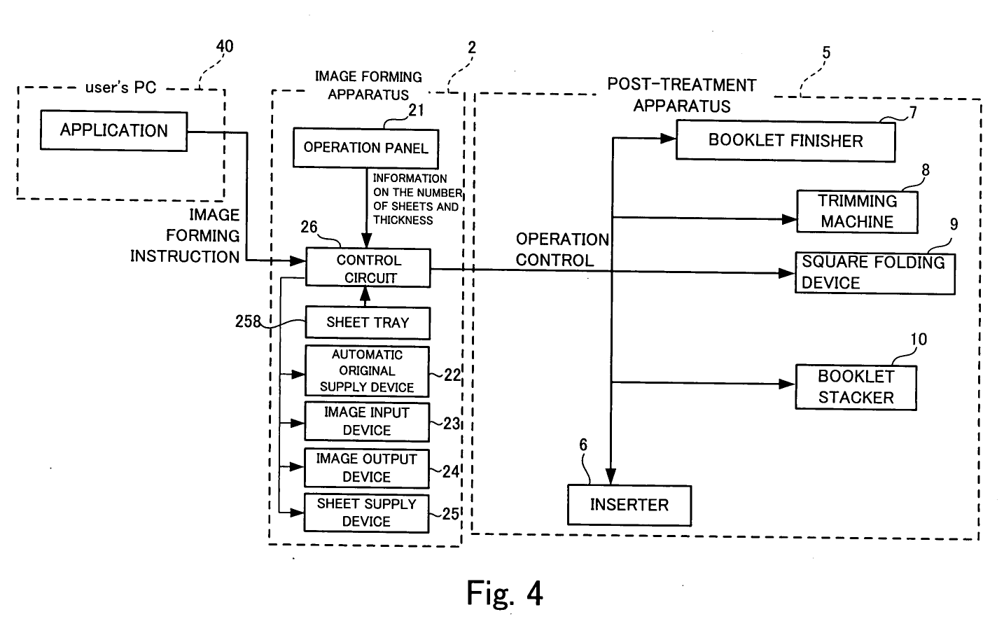

The image output device 24 includes a scanner 241, a photosensitive drum 242, a charging unit 243, a development unit 244, a transfer unit 245, and a cleaner 246. The charging unit 243 evenly charges the photosensitive drum 242. The development unit 244 develops an electrostatic latent image into a toner image. The transfer unit 245 transfers the toner image to the sheet. The cleaner 246 recovers residual toner which is not transferred to the sheet. The image signal from the image input device 23 is converted into an exposure light signal by a laser output unit 241a included in the scanner 241. The exposure light signal passes through a polygon mirror 241b, an fθ lens 241c, and a reflecting objective lens 241d to form the electrostatic latent image on the rotating cylindrical photosensitive drum 242 based on the original image. The scanner 241 starts exposure at predetermined exposure start timing, and the electrostatic latent image is formed by scanning the surface of the photosensitive drum 242 with the exposure light at a predetermined scanning speed. The image signal can also be inputted from a computer (see FIG. 4) externally connected to the image forming apparatus 2. The scanner 241 scans the surface of the photosensitive drum 242 with the exposure light in a rotating axis direction of the photosensitive drum 242, for forming the electrostatic latent image. The electrostatic latent image is developed to obtain the toner image. The toner image is transferred to the sheet, and the cleaner 246 removes the residual toner on the photosensitive drum 242. Then, the charging unit 243 charges the photosensitive drum 242. The photosensitive drum 242 corresponds to an example of the image bearing body described in the invention, and the scanner 241 corresponds to an example of the exposure device described in the invention. On the other hand, when the transfer is finished, the sheet is delivered to the fixing device 247 to fix the toner image. Thus, the image is formed in the sheet. In forming the images on the plural sheets which constitute the booklet, the images are formed in the order from the side opposite to a booklet cover, i.e., in the order from the sheet constituting the inner-most side of the booklet.

The sheet feeder 25 includes a tray 258 (258a, 258b, and 258c), conveyance rollers 259, and adjustment rollers 250. The sheets are loaded on the tray 258. The conveyance rollers 259 and the adjustment rollers 250 convey the sheet loaded on the tray 258 along a conveyance path R through the image output device 24. The adjustment rollers 250 convey the sheet to the transfer unit 245. The conveyance roller 259 and the adjustment roller 250 correspond to an example of the sheet conveyance unit described in the invention.

Returning to FIG. 1, the description will be continued.

The post-treatment apparatus 5 includes the inserter 6, a booklet finisher 7, a trimming machine 8, a square folding device 9, and a stacker 10. The sheets are stored in the inserter 6, and the inserter 6 additionally inserts the sheet as a booklet cover. The booklet finisher 7 binds the sheets to perform saddle stitching, and the booklet finisher 7 folds the sheets. The trimming machine 8 cuts and aligns sides of the booklet. The square folding device 9 performs a booklet finishing process. The booklets are loaded on the stacker 10. The post-treatment apparatus 5 corresponds to an example of the booklet producing unit described in the invention.

The booklet finisher 7 includes a sheet tray 71, a pair of folding rollers 72, and a push-out unit 73. The sheets conveyed from the image forming apparatus 2 through the inserter 6 are bound on the sheet tray 71. The sheets are laid on top of one another on the sheet tray 71 in the order from the side opposite to the booklet cover, i.e., in the order from the sheet constituting the inner-most side of the booklet. The push-out unit 73 is movably provided between the center of the sheet on the sheet tray 71 and the pair of folding rollers 72. When the push-out unit 73 pushes out a central portion of the laid sheets to the position located between the pair of folding roller 72, the sheets are folded into two. The folded sheets are conveyed to the square folding device 9 through the trimming machine 8 while a portion corresponding to a spine of the booklet is in the forefront. The trimming machine 8 includes a cutter 81 that cuts and aligns the sheet. The cutter 81 is provided while being able to be vertically moved. The cutter 81 is moved to cut and align sheet portions corresponding to an edge of the booklet.

The square folding device 9 includes a stop plate 94, a clamping jaw 95, a roller 96, a punch 97, and a carry-out roller 98. The stop plate 94 positions the sheets. The clamping jaw 95 clamps the sheets positioned by the stop plate 94. The roller 96 presses and flattens the sheet portions corresponding to the spine of the booklet. The punch 97 makes a hole in the booklet whose back is flattened. The carry-out roller 98 carries out the booklet to the stacker.

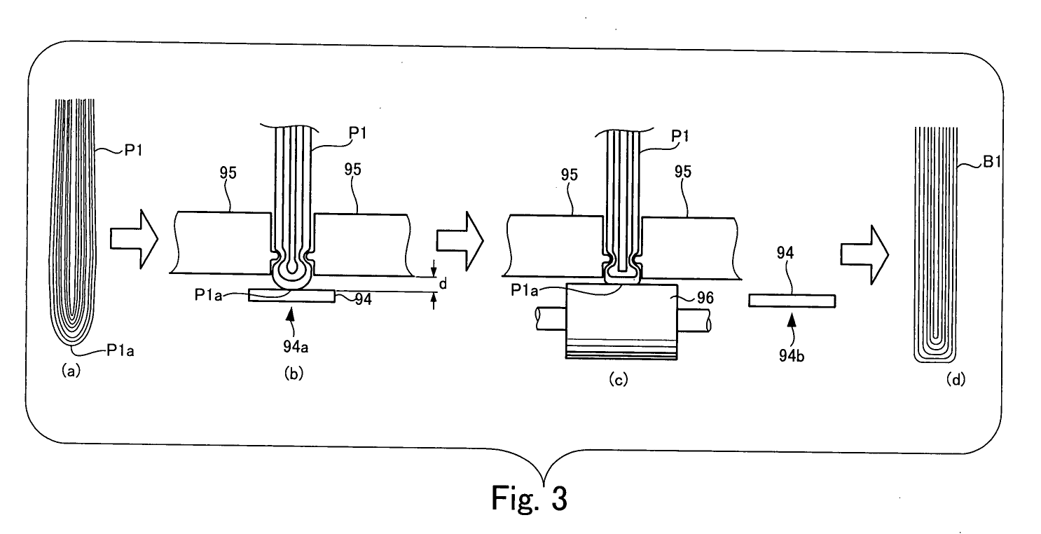

FIG. 3 shows an outline of a function of the square folding device.

The square folding device 9 will be described with reference to FIGS. 1, 2, and 3.

The stop plate 94 can be moved between a position where the stop plate 94 closes a conveyance path of the folded sheet and a position where the stop plate 94 is retracted from the conveyance path. When sheets P1 which are folded while laid on top of one another as shown in part (a) of FIG. 3 is delivered to the square folding device 9, the sheets p1 are positioned by being abutted on the stop plate 94 located at the position where the stop plate 94 closes the sheet path as shown in part (b) of FIG. 3. The clamping jaw 95 clamps the sheets positioned by the stop plate 94 from the cover side, and the clamping jaw 95 holds the booklet while the roller 96 presses a portion P1a of the sheets corresponding to the spine of the booklet. As shown in part (c) of FIG. 3, the roller 96 flattens the portion P1a corresponding to the spine of the booklet by pressing the portion P1a along the portion P1a on the sheets clamped by the clamping jaw 95. Thus, in the post-treatment apparatus 5, by folding the plural sheets are folded while laid on top of one another, and pressing of the sheets, which produces a booklet B1 whose back is flattened, as shown in part (d) of FIG. 3. The booklet B1 whose back is flattened is carried out and loaded onto the stacker 10 by the carry-out roller 98. As shown in part (b) of FIG. 3, because the stop plate 94 located at the position where the stop plate 94 closes the sheet conveyance path is arranged with a predetermined gap to the clamping jaw 95, the sheets P1 are clamped while the portion P1a corresponding to the back is projected from the clamping jaw 95. Because the projected portion is pressed by the roller 96, a contraction amount of the back P1a between the state in which the sheets P1 are folded and the state in which the back P1a is pressed depends on a width d of the gap between the stop plate 94 and the clamping jaw 95 as shown in part (b) of FIG. 3. The square folding device 9 controls the contraction amount of the back P1a is controlled by changing the width d of the gap according to setting of intensity of the square folding process. Specifically, the width d of the gap is 2 mm in a case where the intensity of the square folding process is set at a strong level, and the width d of the gap is 1 mm in a case where the intensity of the square folding process is set at a weak level.

FIG. 4 is a block diagram showing an electric configuration of the image forming system shown in FIG. 1.

The image forming apparatus 2 includes a control circuit 26 that controls the operation of the whole of the image forming system 1. The control circuit 26 has a central processing unit (CPU) (not shown) that controls the operation of the whole of the image forming system based on a program, ROM (not shown) in that the program and a table are stored, RAM (not shown) that temporarily provides a storage area to CPU, and an interface circuit (not shown) that relays a signal between CPU and the outside of the control circuit 26. A personal computer 40 of a user is externally connected to the image forming apparatus 2.

When an image forming instruction is transmitted to the control circuit 26 from the operation panel 21 or from the externally connected user's personal computer 40, the control circuit 26 controls the automatic original supply device 22, the image input device 23, the image output device 24, and the sheet feeder 25 of the image forming apparatus 2 and the control circuit 26 forms the image on the sheet. The control circuit 26 also controls the operations of the booklet finisher 7, the trimming machine 8, the square folding device 9, and the stacker 10. For example, the control circuit 26 controls the drive of each of the clamping jaw 95, the stop plate 94, the roller 96, the punch 97, and the carry-out roller 98. The clamping jaw 95, the stop plate 94, the roller 96, the punch 97, and the carry-out roller 98 are incorporated in the square folding device 9. The control circuit 26 corresponds to an example of the control unit described in the invention.

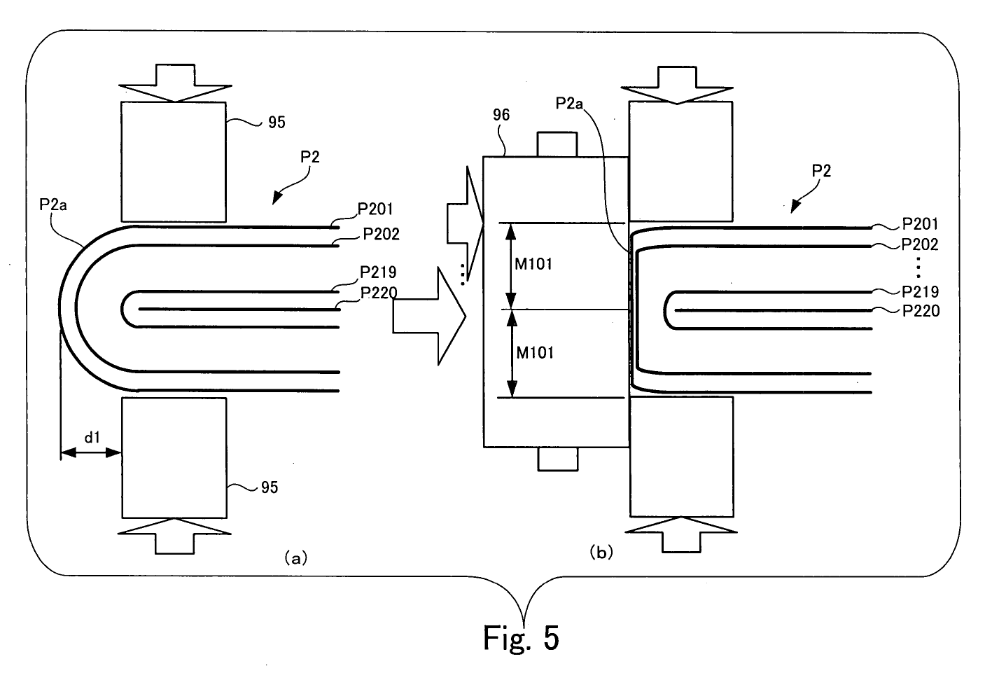

In the image forming system 1 of the first embodiment, the edge close to the center of the double spread in the image forming area is located far away from the center as the sheet is located closer to a booklet cover side by being folded the sheet with the booklet finisher 7. The area where the booklet is flattened with square folding device 9 and the image forming area will be described below with reference to FIGS. 5 to 8.

FIG. 5 schematically shows a state in which the folded sheets are flattened by the square folding device 9. In an example shown in part (a) of FIG. 5, sheets P2 are in the state in which 20 sheets P201 to P220 are folded while laid on top of one another. The sheets P203 to P218 on the sheets P201 to P220 will be omitted in FIG. 5. When the sheets P2 are clamped by the clamping jaw 95, a portion P2a of the sheets P2 corresponding to the back is projected from the clamping jaw 95 by a length equal to a width d1 of the gap between the stop plate 94 and the clamping jaw 95 as shown in part (b) of FIG. 3. FIG. 5 shows the state of the case in which the intensity of the square folding process is set at the strong level. In this case, the portion P2a corresponding to the back is projected by the length d1 of 2 mm. Then, as shown in part (b) of FIG. 5, the roller 96 flattens the portion P2a corresponding to the back by pressing the portion P2a. The contraction amount of portion P2a corresponding to the back from the state shown in part (a) of FIG. 5 in which the sheets P2 are folded to the state shown in part (b) of FIG. 5 in which the portion P2a corresponding to the back is pressed is the length d1 by which the portion P2a corresponding to the back is projected. That is, the contraction amount of portion P2a corresponding to the back is controlled according to the setting of the intensity of the square folding process. In the case where the contraction amount of portion P2a corresponding to the back is the length d1 of 2 mm, as shown in part (b) of FIG. 5, the portion P2a corresponding to the back is flattened in the whole of the thickness of the sheets P2. When the image is formed in the flattened area, the crease is located in the image to disturb the image, or the image in the back portion is lost because the image in the back portion is hidden behind the back of the adjacent sheet. Accordingly, the flattened area becomes an area where the image formation is forbidden. At this point, sizes of the flattened area differ from one another for the sheets P201 to P220. For example, on the sheet P201, a distance (hereinafter referred to as forbidden distance) M101 to the edge from the center of the area where the image formation is forbidden is substantially equal to the thickness of 20 sheets of 0.087×20=1.74 mm, in the case where the folded sheets P2 is formed by the 20 sheets which have a thickness of 0.087 mm each. On the sheet P202 located inside the sheet P201, a forbidden distance M102 becomes the thickness of the 19 sheets of 0.087×19=1.653 mm. Thus, the forbidden distance on each sheet can be computed from the number of sheets, the position of the sheet, and the thickness of the sheets constituting the booklet.

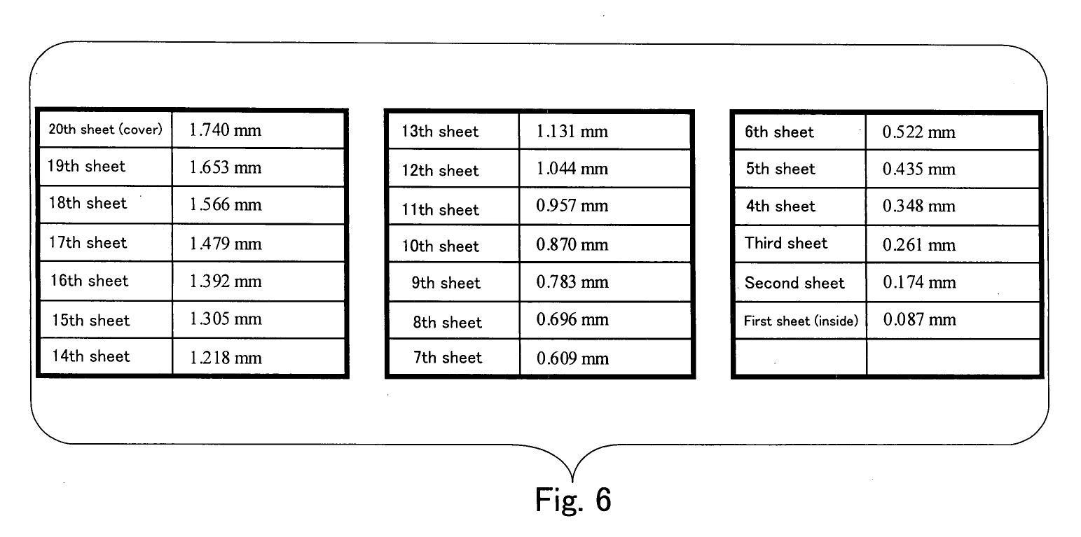

FIG. 6 is a table showing the forbidden distance on each sheet.

FIG. 6 shows the forbidden distances M101 to M120 of the sheets in the case where the 20 sheets which have a thickness of 0.087 mm each are folded while the intensity of the square folding process is set at the strong level. In the table of FIG. 6, a value corresponding to a field of “20th sheet” indicates the forbidden distance M101. “19th sheet”, “18th sheet”, and “first sheet” indicate M102, M103, . . . , and M120 respectively. The forbidden distance also depends on the setting of the intensity of the square folding process.

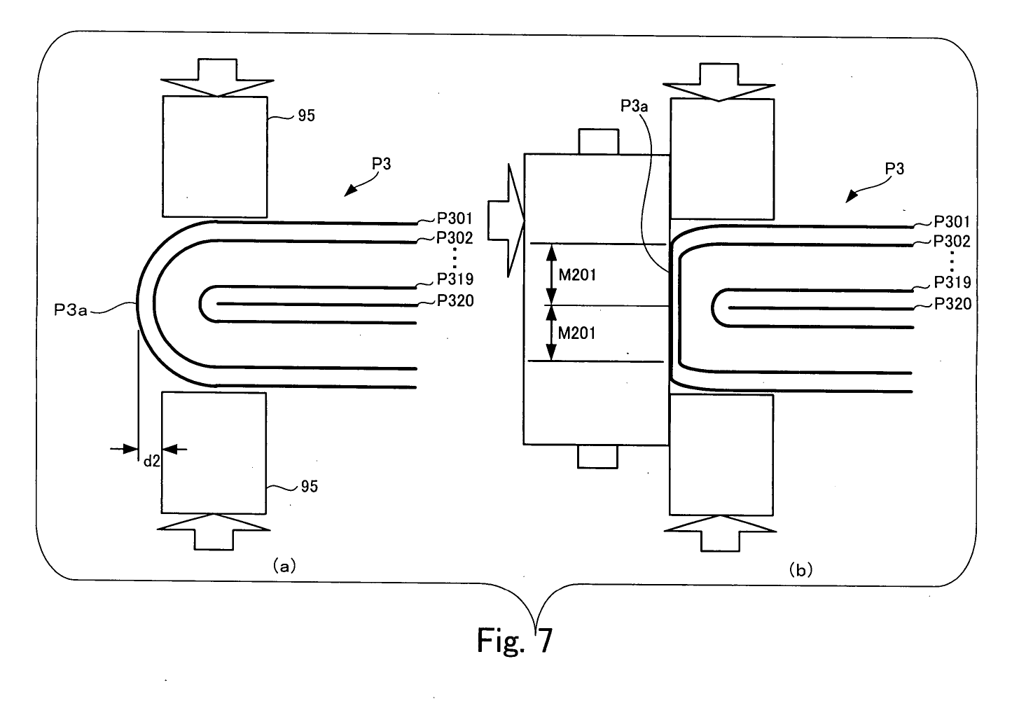

FIG. 7 schematically shows a state in which the folded sheets are flattened by the square folding device 9. As shown in part (a) of FIG. 7, sheets P3 folded while laid on top of one another are clamped by the clamping jaw 95 of the square folding device 9. In this case, the intensity of the square folding process is set at the weak level, and a width d2 of the gap between the stop plate 94 shown in part (b) of FIG. 3 and the clamping jaw 95 is 1 mm. Accordingly, a portion P3a corresponding to the back of the sheets P3 is projected from the clamping jaw 95 by d2 of 1 mm. In this case, the contraction amount of portion P3a corresponding to the back from the state shown in part (a) of FIG. 7 in which the sheets P3 are folded to the state shown in part (b) of FIG. 7 in which the portion P3a corresponding to the back is pressed is d2 of 1 mm. At this point, of 20 sheets P301 to P320, the ten sheets P301 to P310 from the cover side are pressed, and the sheets P311 to P320 located inside the sheets P301 to P310 are not pressed because the sheets P311 to P320 are not affected by the flattening by the roller 96. As a result, as shown in part (b) of FIG. 7, the portion P3a corresponding to the back is flattened by a half width of the thickness of the sheets P3. Therefore, a forbidden distance M201 on the sheet P301 on the outer-most side is substantially equal to the thickness of the ten sheets of 0.087×10=0.87 mm.

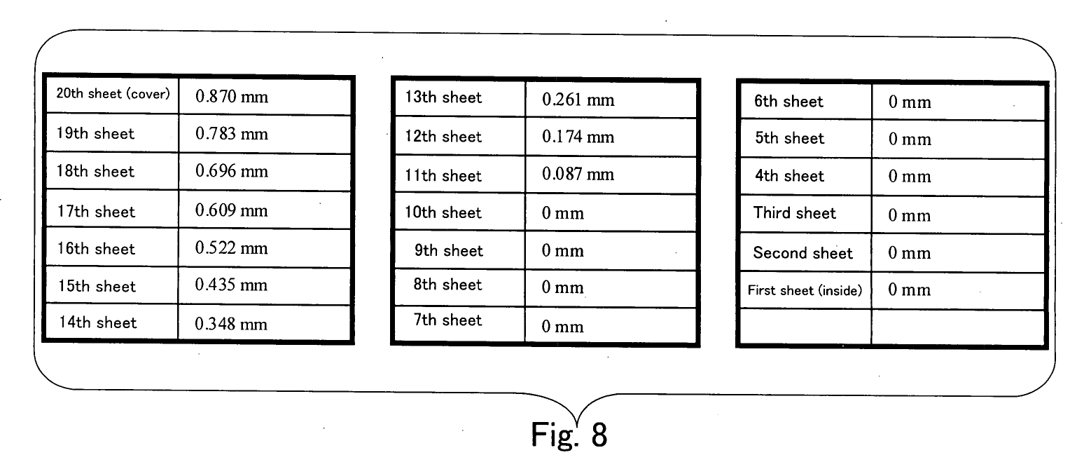

FIG. 8 is a table showing the forbidden distance on each sheet.

FIG. 8 shows the forbidden distances M201 to M220 of the sheets in the case where the 20 sheets which have a thickness of 0.087 mm each are folded while the intensity of the square folding process is set at the weak level. In the table of FIG. 8, the value corresponding to the field of “20th sheet” indicates the forbidden distance M201, and “19th sheet”, “18th sheet”, and “first sheet” indicate M202, M203, . . . , and M220 respectively. In the table of FIG. 8, the reason why the forbidden distance M211 corresponding to “10th sheet” to the forbidden distance M220 corresponding to “first sheet” become 0 mm is that the sheets P311 to P320 corresponding to the “10th sheet” to “first sheet” are not pressed by the roller 96.

Thus, in the state in which the portions P2a and P3a corresponding to the booklet back are pressed, the contraction amount of portions P2a and P3a depend on the width of the gap between the stop plate 12 and the clamping jaw 95, and the forbidden distances M101 to M120 and M201 to M220 depend on the contraction amount of portions P2a and P3a corresponding to the booklet back.

As described above, the forbidden distance on each sheet is computed from the number of the sheets constituting the booklet, the position of the sheet, the thickness of the sheets, and the setting of the intensity of the square folding process.

A procedure of determining a distance from the center to the edge close to the center of the double spread in the image forming area, where the image is formed, according to the forbidden distance will be described below.

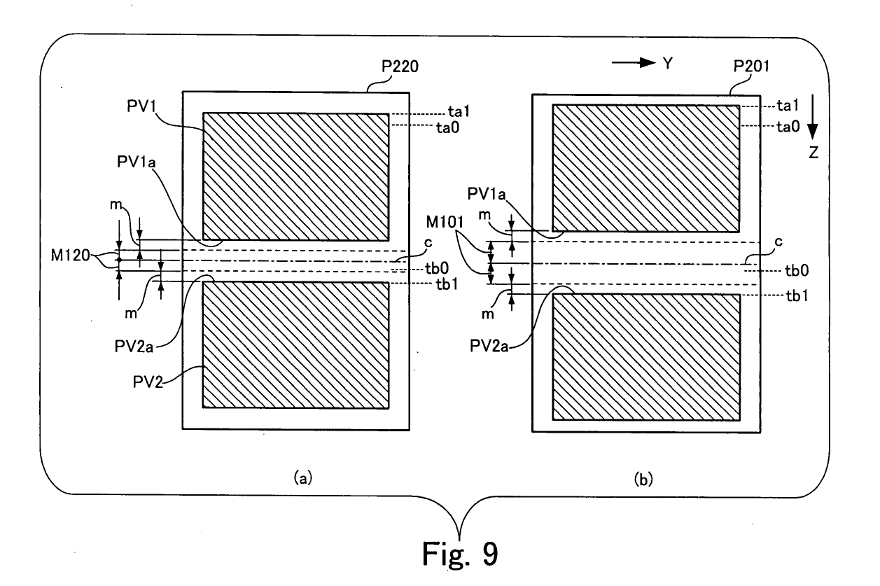

FIG. 9 shows the image forming area on the sheet.

Part (a) of FIG. 9 shows the sheet P220 located on the inner-most side as an example of the sheet. The sheet P220 is located on the side opposite to the booklet cover side. Part (b) of FIG. 9 shows the sheet P201 located on the side closest to the booklet cover. The image output device 24 forms the image in a direction shown by an arrow Z on the sheets P220 and P201. The conveyance roller 259 and adjustment roller 250 shown in FIG. 2 convey the sheets P220 and P201 in the direction opposite to the direction shown by the arrow Z. The surface of each of the sheets P220 and P201 corresponds to two pages of the booklet because the surface is folded. Therefore, each two image forming areas PV1 and PV2 corresponding to the two pages of the booklet are arranged on each of the sheets P220 and P201. A center C of the sheet becomes the center of the double spread of the booklet.

As shown in FIG. 9, in the image forming areas PV1 and PV2 where the images are formed on the sheet, the distance between the center C and edges PV1a and PV2a close to the center becomes a distance in which a predetermined marginal width m is added to the width between the center of the area where the image formation is forbidden and the center C. For example, as shown in part (a) of FIG. 9, on the sheet P220 located inside on the side opposite to the booklet cover side, the distance between the center C of the sheet P220 and the edges PV1a and PV2a becomes the distance in which the marginal width m is added to the forbidden distance M120. As shown in part (b) of FIG. 9, on the sheet P201 located on the booklet cover side, the distance between the center C of the sheet P201 and the edges PV1a and PV2a becomes the distance in which the marginal width m is added to the forbidden distance M101.

As described above, the forbidden distance is increased as the sheet is located closer to the booklet cover side when the sheet is folded. Therefore, the edges PV1a and PV2a close to the center of the double spread are located farther away from the center C of the sheet as the sheet is located closer to the booklet cover side.

The forbidden distance depends on the setting of the intensity of the square folding process. The contraction amount of the back also depends on the setting of the intensity of the square folding process. Accordingly, the edges PV1a and PV2a close to the center of the double spread of the image forming areas PV1 and PV2 is located according to the contraction amount of the back, because the edges PV1a and PV2a are determined according to the forbidden distance.

In the first embodiment, the positions of the edges PV1a and PV2a of the image forming areas PV1 and PV2 on the sheet are controlled by exposure start timing at which the scanner 241 scans the surface of the photosensitive drum 242 in the rotating axis direction of the photosensitive drum 242 with exposure light. FIG. 9 shows the image forming area on the sheet. At this point, the image on the sheet is one in which the toner image obtained in the surface of the photosensitive drum 242 is transferred and fixed. The toner image is obtained when the electrostatic latent image that is formed by scanning the surface of the rotating photosensitive drum 242 with the exposure light of the scanner 241 is developed. Therefore, FIG. 9 shows both the image forming area on the sheet and the state in which the electrostatic latent image formed by scanning the surface of the rotating photosensitive drum 242 with the exposure light using the scanner 241 is spread out in a plane. In this case, the direction shown by an arrow Y corresponds to the direction in which the scanner 241 scans the surface of the rotating photosensitive drum 242 in the rotating axis direction of the photosensitive drum 242 with the exposure light. On the other hand, as time advances, the electrostatic latent image is formed in the direction shown by the arrow Z by the rotation of the photosensitive drum 242. That is, the arrow Z of FIG. 9 also indicates a time axis direction when the scanner 241 forms the electrostatic latent image on the surface of the photosensitive drum 242.

The control circuit 26 (see FIG. 4) sets the exposure start timing in the scanner 241 such that the distance from the center C of the sheet P220 to the edges PV1a and PV2a close to the sheet center of the image forming areas PV1 and PV2 becomes the distance in which the predetermined marginal width m is added to the forbidden distance. In the case where the direction shown by the arrow Z of FIG. 9 is the time axis direction, exposure start timing ta1 of the electrostatic latent image for forming the image in the image forming area PV1 of the sheet P220 shown in part (a) of FIG. 9 is set earlier than exposure start timing ta0 by a time period while the surface of the photosensitive drum 242 is moved by the distance of the forbidden distance M120. The exposure start timing ta0 is a reference in the case where the flattening is not performed by the square folding device 9. The exposure start timing ta1 is determined from the computation of a circumferential velocity of the photosensitive drum 242. The start of the exposure at the exposure start timing ta1 earlier than the exposure start timing ta0 makes it earlier that the exposure of the electrostatic latent image is ended with respect to the image in the image forming area PV1. As a result, the distance from the center C of the sheet P220 to the edge PV1a close to the center of the image forming area PV1 becomes the distance in which the marginal width m is added to the forbidden distance M120, after the electrostatic latent image formed on the surface of the photosensitive drum 242 is developed to be transferred to the sheet P220. On the other hand, the exposure start timing tb1 of the electrostatic latent image for forming the image in the image forming area PV2 of the sheet P220 is set later than the exposure start timing ta0 by the time period while the surface of the photosensitive drum 242 is moved by the distance of the forbidden distance M120, and the exposure is started at the later exposure start timing tb1. The exposure start timing ta0 is the reference in the case where the flattening is not performed by the square folding device 9. Therefore, the distance from the center C of the sheet P220 to the edge PV2a close to the center of the image forming area PV2 becomes the distance in which the marginal width m is added to the forbidden distance M120, after the electrostatic latent image formed in the surface of the photosensitive drum 242 is developed to be transferred the toner image to the sheet P220. For other sheets P202 to P219, the exposure start timing ta1 or tb1 is made earlier or later than the exposure start timing ta0 or tb0 according to the forbidden distances M102 to M119 respectively. Therefore, the distance from the center C to the edge PV1a close to the center of the image forming area PV1 and the distance from the center C to the edge PV2a close to the center of the image forming area PV2 become the distance in which the marginal width m is added to each of the forbidden distances M102 to M119. Accordingly, the start of the formation of the electrostatic latent image is controlled by the exposure start timing depending on the sheet position in the booklet. Thus, the position of the edge close to the center of the image forming area can be precisely controlled.

The image formation and bookbinding process in the image forming system 1 will be described below.

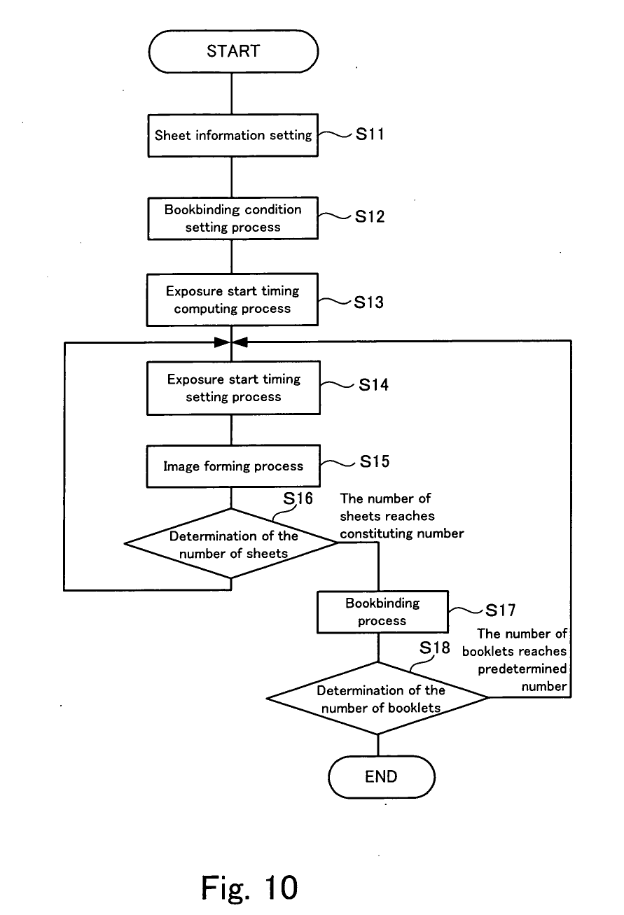

FIG. 10 is a flowchart showing the image formation and bookbinding process in the image forming system.

On the basis of a program, the control circuit 26 shown in FIG. 4 controls the operation of each unit to realize the image formation and bookbinding process shown in FIG. 10. The flow chart of FIG. 10 will be described with reference to FIG. 4.

In the image formation and bookbinding process, first the control circuit 26 performs a sheet information obtaining process (Step S11). The control circuit 26 causes the operation panel 21 to display a message for encouraging a user to input information on the thickness for each size of the sheets having different sizes stored in the tray 258 and the inserter 6. When the user operates the operation panel 21 to input the information on the thickness, the inputted information is supplied to the control circuit 26.

Then, the control circuit 26 performs a bookbinding condition setting process (Step S12). The control circuit 26 causes the operation panel 21 to display the message that encourages the user to input the pieces of information on the number of sheets constituting the booklet, the size of the sheet used, and the intensity of the square folding process. When the user operates the operation panel 21 to input the pieces of information on the number of sheets constituting the booklet, the size of the sheet used, and the intensity of the square folding process, the inputted pieces of information are supplied to the control circuit 26 and a job for producing the booklet is instructed. At this point, the control circuit 26 obtains information on the number of sheets constituting the booklet from the user. The control circuit 26 also obtains sheet thickness information on the sheet thickness corresponding to the sheet size used. The tray in that the corresponding sheets are stored is selected according to the information on the sheet size.

The control circuit 26 performs an exposure start timing computing process (Step S13). The exposure start timing is timing at which the scanner 241 starts the scanning of the surface of the photosensitive drum 242 with the exposure light, and the exposure start timing depends on the sheet constituting the booklet. The control circuit 26 computes the forbidden distance for each sheet position in the booklet by using the number of sheets indicated by the information on the number of sheets, the sheet thickness indicated by the information on the sheet thickness, and the setting of the intensity of the square folding process that has an influence on the contraction amount of back. Then, the control unit 26 computes the exposure start timing according to the computed forbidden distance. For each sheet, the two pieces of exposure start timing ta1 and tb1 are computed corresponding to the image forming areas PV1 and PV2 arranged on each sheet.

The control circuit 26 performs an exposure timing setting process (Step S14). In the exposure timing setting process, according to the sheet position in the booklet where the next image is formed, i.e., according to the order of the sheet from the booklet cover, the control circuit 26 selects and sets the exposure start timing from the pieces of exposure start timing determined for each sheet in Step S13.

Then, the control circuit 26 performs an image forming process (Step S15). The control circuit controls each of the devices of the image forming apparatus 2 to form the image on one sheet. For example, while the control circuit 26 causes the photosensitive drum 242 to rotate at a constant speed, the control circuit 26 causes the scanner 241 to start the formation of the electrostatic latent image on the photosensitive drum 242 at the timing set in Step S14. The control circuit 26 also causes the conveyance roller 259 and adjustment roller 250 to convey the sheet at predetermined conveyance start timing.

When the image formation for a sheet is finished to one sheet, the control circuit 26 determines whether or not a counter value of the number of sheets becomes the number of sheets constituting the booklet (Step S16). When the control circuit 26 determines that the counter value becomes the number of sheets constituting the booklet, the control circuit performs the bookbinding process in Step S17. When the control circuit 26 determines that the counter value does not reach the number of sheets constituting the booklet, the control circuit forms the images in the image forming areas according to the positions of the sheet edges in the booklet for all the sheets constituting the booklet by repeating the processes from Step S14.

In Step S17, the bookbinding process is performed. Specifically, the booklet finisher 7 binds the sheets. Then, the booklet finisher 7 performs saddle stitching while the sheets are laid on top of one another, and the booklet finisher 7 folds the sheets. The trimming machine 8 cuts and aligns the side of the folded sheets corresponding to the edge of the booklet, and the square folding device 9 flattens the portion corresponding to the spine of the booklet according to the setting of the intensity of the square folding process. This enables the production of the booklet whose back is flattened.

Then, the control circuit 26 performs determination of the number of booklets (Step S18). The control circuit 26 determines whether or not the number of bound booklets reaches the specified number of booklets. When the control circuit 26 determines that the number of bound booklets does not reach the specified number of booklets, the control circuit continues the production of the booklet by repeating the processes from Step S14. When the control circuit 26 determines that the number of bound booklets reaches the specified number of booklets, the image formation and bookbinding process is ended.

According to the first embodiment, as shown in FIG. 9, in image forming areas PV1 and PV2 where the images are formed, the edges PV1a and PV1b close to the center of the double spread are separated away from the center, and the images are formed in the areas separated away from the flattened portion P2a corresponding to the spine of the booklet. The flattened area indicated by each of the forbidden distances M101 to M120 is enlarged as each of the sheets P201 to P220 is located closer to the booklet cover side. However, according to the first embodiment, the edges PV1a and PV1b of the image forming areas are located farther away from the center as the sheet is located closer to the booklet cover side, so that the image is properly formed while separated away from the flattened portion according to the sheet position in the booklet. Accordingly, the image disturbance by the flattening is prevented in the back portion of the booklet and the lack of the image is also prevented in the crease, so that the booklet quality can be improved.

Because the edges PV1a and PV1b of the image forming areas are located farther away from the center as the sheet is located closer to the booklet cover side, the image positions are aligned with respect to the center of the double spread when the booklet is opened. Therefore, the booklet has the high quality.

The width of the flattened portion depends on the contraction amount of the pressed back. The edge close to the center of the image forming area is located at the distance according to the setting of the intensity of the square folding process. Therefore, the edge is located at the distance according to the contraction amount of back, which enables the image to be properly formed in the area according to a degree in which the spine of the booklet is flattened.

The edges PV1a and PV1b of the image forming areas where the images are formed are located at the distance according to the number of sheets constituting the booklet and the sheet thickness, accordingly the image can be properly formed in the area according to the booklet thickness which depends on the number of sheets.

In the first embodiment, the photosensitive drum is described as an example of the image bearing body. However, a photosensitive belt may be used as image bearing body. Even in the case where the image forming apparatus includes the exposure devices of at least four colors of Y (yellow), M (magenta), C (cyan), and K (black), the plural exposure devices may similarly be controlled.

### Second Embodiment

In the first embodiment, the timing at which the formation of the electrostatic latent image is started is controlled at the computed exposure start timing by the scanner 241. However, the change in position of the edge PV1a of the image forming area is not limited only to the control of the start timing of the scanner 241. Then, a second embodiment of the invention will be described. In the second embodiment, the sheet conveyance start timing is simultaneously controlled by an adjustment roller 250. In the following description of the second embodiment, the same component is designated by the same numeral as the first embodiment, and a difference between the first embodiment and the second embodiment will be described below.

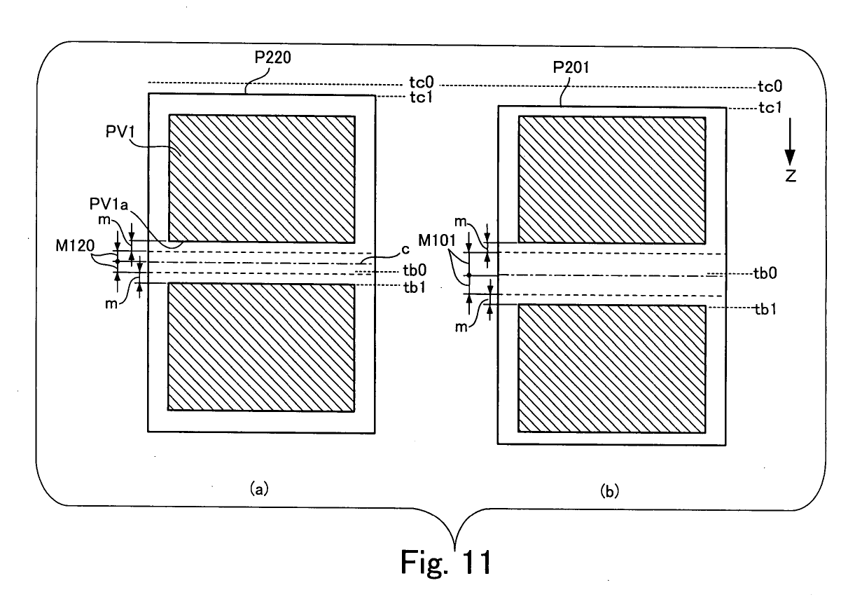

FIG. 11 shows an image forming area on the sheet in the second embodiment of the invention.

Part (a) of FIG. 11 shows the sheet P220 located on the inner-most side as an example of the sheet. The sheet P220 is located on the side opposite to the booklet cover side. Part (b) of FIG. 9 shows the sheet P201 located on the side closest to the booklet cover. The sheets P220 and P201 are conveyed in the direction opposite to the direction shown by the arrow Z with the conveyance roller 259 and the adjustment roller 250 as shown in FIG. 2.

In the second embodiment, the edge close to the center of the double spread is located farther away from the center C as the sheet is located closer to the booklet cover side. Therefore, in the adjustment roller 250, the conveyance start timing is adjusted for each sheet.

In the second embodiment, the control circuit 26 (see FIG. 4) sets the conveyance start timing in the adjustment roller 250 such that the distance from the center C of the sheet P220 to the edge PV1a close to the sheet center of the image forming area PV1 becomes the distance in which the predetermined marginal width m is added to the forbidden distance. That is, in the case where the direction shown by the arrow Z of FIG. 11 is set to the time axis, conveyance start timing tc1 at which the adjustment roller 250 starts the conveyance of the sheet P220 shown in part (a) of FIG. 11 is set later than the conveyance start timing tc0 by a time period while the surface of the photosensitive drum 242 is moved by the distance of the forbidden distance M120. The conveyance start timing tc0 is the timing in the case where the flattening is not performed by the square folding device 9. The conveyance start timing tc1 is determined by the computation from the circumferential speed of the photosensitive drum 242. The sheet conveyance is started at the later conveyance start timing tc1, which relatively makes it earlier that the transfer of the toner image to the sheet is completed in the image forming area PV1. Therefore, with the image which is transferred and fixed to the sheet P220, the distance from the center C of the sheet P220 to the edge PV1a close to the center of the image forming area PV1 becomes the distance in which the marginal width m is added to the forbidden distance M120.

In the second embodiment, through the processes in Steps S13 and S14 of FIG. 10, the control circuit 26 computes and sets the conveyance start timing along with the exposure start timing.

Thus, because the start of the sheet conveyance is controlled by the conveyance start timing determined based on the sheet position in the booklet, similarly by the start timing control of the electrostatic latent image formation in the first embodiment, the position of the edge close to the center of the image forming area can precisely be controlled. In the second embodiment, because the sheet conveyance start timing is changed, similarly to the image forming area PV1, the position movement occurs in the image forming area PV2. For the image forming area PV2, in consideration of the delay of the sheet conveyance start timing, the exposure start timing tb1 for forming the electrostatic latent image is further delayed.

In the second embodiment, the conveyance start timing is adjusted by the adjustment roller. Alternatively, a timing adjustment sensor is provided at a position of the adjustment roller, the sheet is not temporarily stopped at the adjustment roller, and the sheet is accelerated or decelerated in a period during which the image forming area PV1 reaches the photosensitive drum since the sensor detects a front end of the sheet. This may enable the control of the time when the image forming area PV1 reaches the photosensitive drum to adjust the exposure start timing. Similarly in the image forming area PV1, the position movement occurs in the image forming area PV2 because the sheet conveyance start timing is changed. However, the time when the image forming area PV2 reaches the photosensitive drum may be controlled and then the exposure start timing from the center C is adjusted through accelerating or decelerating the sheet in the period from when the image forming area PV1 passes through the photosensitive drum to when the image forming area PV2 reaches the photosensitive drum.

### Third Embodiment

In the above embodiments, the photosensitive drum 242 forms the electrostatic latent image at a constant speed. That is, the speed at which the scanner 241 scans the surface of the photosensitive drum 242 in the rotating axis direction of the photosensitive drum 242 with the exposure light is kept constant. However, the position of the edge PV1a of the image forming area can also be changed through changing the scanning speed of the scanner 241. Then, a third embodiment of the invention will be described. In the third embodiment, the scanner 241 controls the scanning speed. In the following description of the third embodiment, the same component is designated by the same numeral as the above embodiments, and the difference between the third embodiment and the above embodiments will be described below.

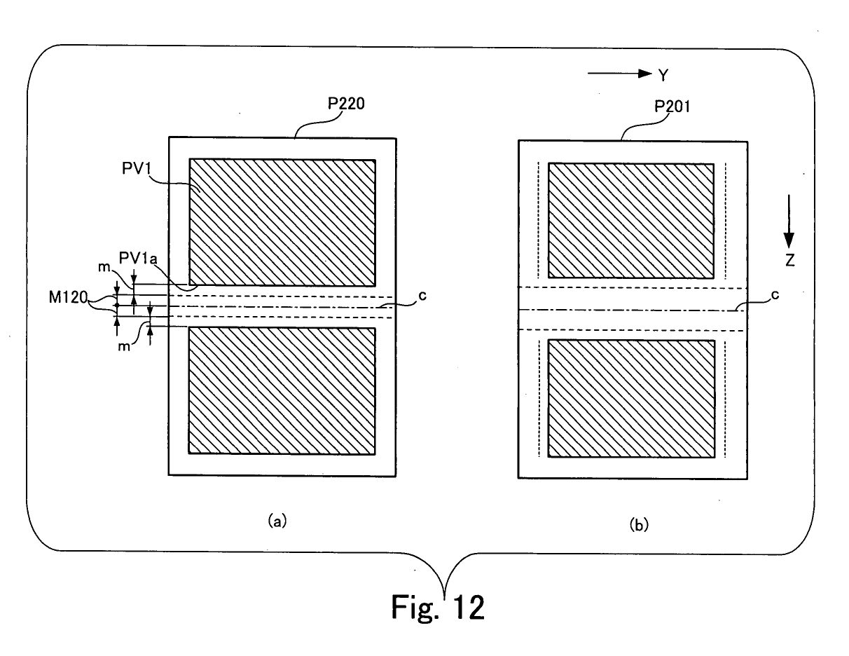

FIG. 12 shows the image forming area on the sheet in the third embodiment of the invention.

Part (a) of FIG. 12 shows the sheet P220 located on the inner-most side as an example of the sheet. The sheet P220 is located on the side opposite to the booklet cover side. Part (b) of FIG. 12 shows the sheet P201 located on the side closest to the booklet cover. The image output device 24 forms the image in the direction shown by the arrow Z on the sheets P220 and P201.

In the third embodiment, the speed at which the scanner 241 scans the surface of the photosensitive drum 242 in the rotating axis direction of the photosensitive drum 242 with the exposure light is increased as the sheet is located closer to the booklet cover side.

In the third embodiment, the control circuit 26 (see FIG. 4) sets the scanning speed of the scanner 241 such that the distance from the center C of the sheet P220 to the edge PV1a close to the sheet center of the image forming area PV1 becomes the distance in which the predetermined marginal width m is added to the forbidden distance. That is, in the case where the direction shown by the arrow Z of FIG. 12 is set to the time axis, the scanning speed of the scanner 241 is increased such that the scanning is ended earlier by the time period while the surface of the photosensitive drum 242 moves over the distance of the forbidden distance M120. The accelerated speed is determined by the computation from the circumferential speed of the photosensitive drum 242. The scanner 241 scans the surface of the photosensitive drum 242 at the high scanning speed, which makes it earlier that the exposure of the electrostatic latent image is ended for the image of the image forming area PV1, while the exposure start timing or the sheet conveyance start timing is kept constant. That is, the width in the direction of the end of the double spread from the center of the double spread of the to be formed becomes shortened. Therefore, in the image which is transferred and fixed to the sheet P220, the distance from the center C of the sheet P220 to the edge PV1a close to the center of the image forming area PV1 becomes the distance in which the marginal width m is added to the forbidden distance M120.

Thus, because the scanner 241 is controlled by the scanning speed determined based on the sheet position in the booklet, similarly by the start timing control of the electrostatic latent image formation in the first embodiment, the position of the edge close to the center of the image forming area can precisely be controlled. Further, in accordance with the third embodiment, because the width in the direction of the end of the double spread from the center of the double spread of the to be formed becomes shortened according to the change in position of the edge close to the center, the position of the edge close to the double spread end of the image forming area is kept constant for all the sheets.

In the third embodiment, because the scanning speed of the scanner 241 is changed, not only the width in the direction of the end of the double spread from the center of the double spread of the formed image but also the width in the direction of the spine of the booklet become shortened. In the third embodiment, the scanning speed of the scanner 241 is changed. Therefore, for the image forming area PV2, in consideration of shortening the image width, it is necessary to delay the start timing for forming the electrostatic latent image.

In the third embodiment, through the processes in Steps S13 and S14 of FIG. 10, the control circuit 26 computes and sets the scanning speed of the scanner 241 along with the exposure start timing.

### Fourth Embodiment

In the third embodiment, the scanning speed of the scanner 241 is changed. However, the position of the edge PV1a of the image forming area can also be changed through changing the conveyance speed of the adjustment roller 250 while the scanning speed of the scanner 241 is kept constant. Then, a fourth embodiment of the invention will be described. In the fourth embodiment, the conveyance speed of the adjustment roller 250 is controlled. In the following description of the fourth embodiment, the same component is designated by the same numeral as the above embodiments, and the difference between the fourth embodiment and the above embodiments will be described below.

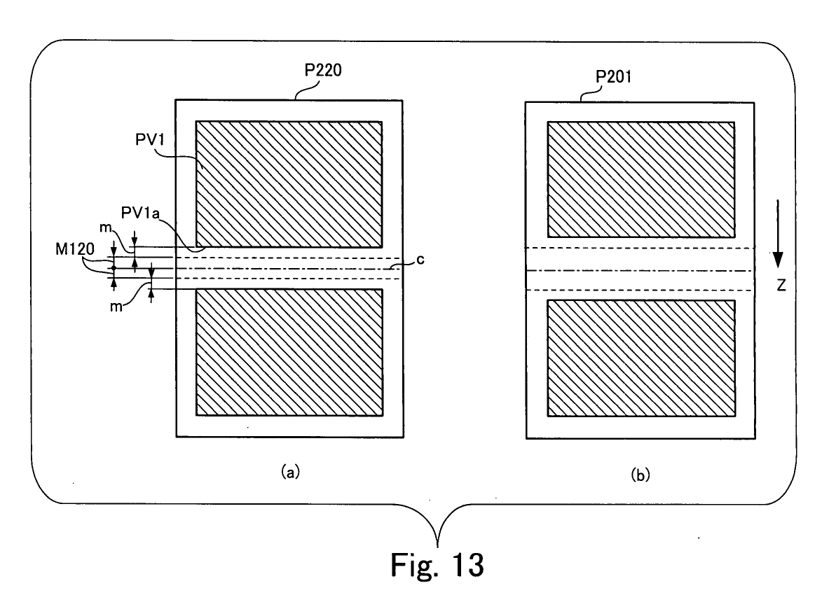

FIG. 13 shows the image forming area on the sheet in the fourth embodiment of the invention.

Part (a) of FIG. 13 shows the sheet P220 located on the inner-most side as an example of the sheet. The sheet P220 is located on the side opposite to the booklet cover side. Part (b) of FIG. 13 shows the sheet P201 located on the side closest to the booklet cover. The image output device 24 forms the image in the direction shown by the arrow Z on the sheets P220 and P201.

In the fourth embodiment, the conveyance speed of the adjustment roller 250 is decreased as the sheet is located closer to the booklet cover side.

In the fourth embodiment, the control circuit 26 (see FIG. 4) sets the conveyance speed of the adjustment roller 250 such that the distance from the center C of the sheet P220 to the edge PV1a close to the sheet center of the image forming area PV1 becomes the distance in which the predetermined marginal width m is added to the forbidden distance. That is, in the case where the direction shown by the arrow Z of FIG. 13 is set to the time axis, the conveyance speed of the adjustment roller 250 is further decreased such that the sheet is delayed by the distance of the forbidden distance M120 at the time when the transfer of the electrostatic latent image corresponding to the edge PV1a close to the sheet center of the image forming area PV1 to the sheet is finished. The decelerated speed is determined by the computation from the circumferential speed of the photosensitive drum 242. The adjustment roller 250 conveys the sheet at the slow conveyance speed, which allows the width in the direction of the end of the double spread from the center of the double spread of the to be formed to be shortened while the exposure start timing is kept constant. Therefore, in the image which is transferred and fixed to the sheet P220, the distance from the center C of the sheet P220 to the edge PV1a close to the center of the image forming area PV1 becomes the distance in which the marginal width m is added to the forbidden distance M120.

Thus, because the conveyance of the adjustment roller 250 is controlled at the conveyance speed determined based on the sheet position in the booklet, similarly by the start timing control of the electrostatic latent image formation in the first embodiment, the position of the edge close to the center of the image forming area can precisely be controlled. Further, in accordance with the fourth embodiment, the width of the image in the direction of the end of the double spread from the center of the double spread becomes shortened according to the change in position of the edge close to the center, the position of the edge close to the double spread end of the image forming area is kept constant for all the sheets. In the fourth embodiment, because the scanning speed of the scanner 241 is kept constant, the width of the formed image in the direction of the spine of the booklet is not shortened. In the fourth embodiment, the conveyance speed of the adjustment roller 250 is changed. Therefore, for the image forming area PV2, in consideration of the image width shortened, the start timing for forming the electrostatic latent image is delayed. Alternatively, the sheet is accelerated or decelerated in the period during which the image forming area PV2 reaches the photosensitive drum since the image forming area PV1 passes through the photosensitive drum. This may enable the control of the time when the image forming area PV2 reaches the photosensitive drum to adjust the exposure start timing of the electrostatic latent image.

In the fourth embodiment, through the processes in Steps S13 and S14 of FIG. 10, the control circuit 26 computes and sets the conveyance speed of the adjustment roller 250 along with the exposure start timing.

### Fifth Embodiment

In the fourth embodiment, the area where the image formation is forbidden is limited to the portion where the back is flattened. However, the area where the image formation is forbidden can be enlarged. A fifth embodiment of the invention will be described below. In the fifth embodiment, the area where the image formation is forbidden is further enlarged. In the following description of the fifth embodiment, the same component is designated by the same numeral as the above embodiments, and the difference between the fifth embodiment and the above embodiments will be described below.

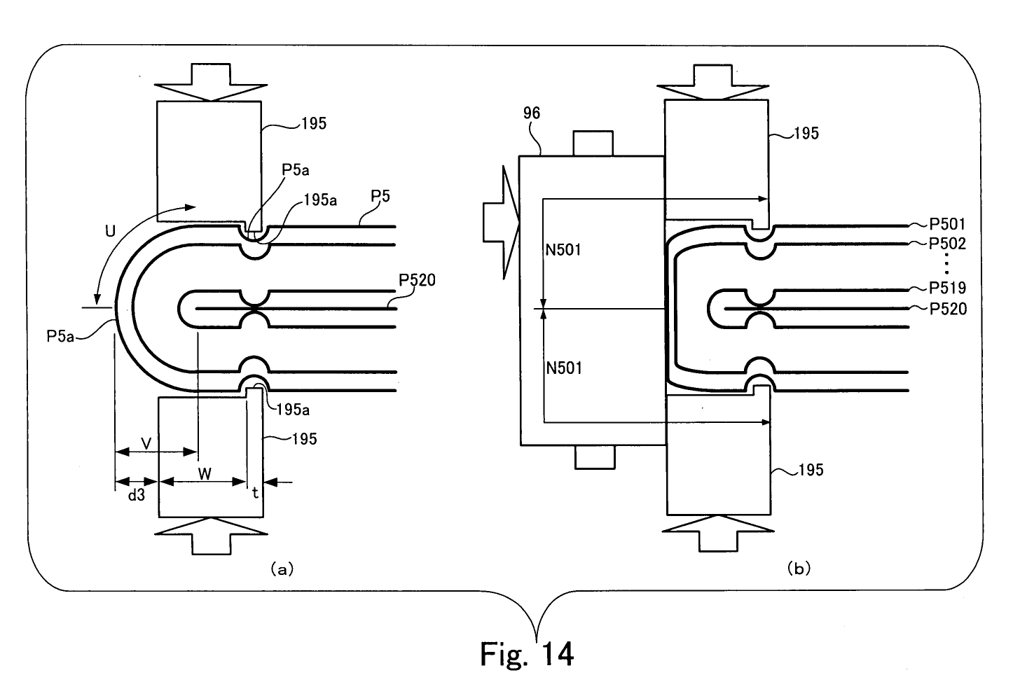

FIG. 14 schematically shows a state in which the folded sheets are flattened by the square folding device 9 in the fifth embodiment of the invention.

For example, as shown in part (a) of FIG. 14, sheets P5 include 20 sheets P501 to P520 which are folded while laid on top of one another. The fifth embodiment differs from the above embodiments in that a clamping jaw 195 of the square folding device 9 has a projection 195a in the surface in which the clamping jaw 195 clamps the booklet P5. In this case, a recess P5a is formed in the portion which is clamped by the projection 195a of the clamping jaw 195. When the image is formed in the recess P5a, the disturbance of image occurs in the recess P5a, or the image is lost. Accordingly, in the case where the clamping jaw 195 has the projection 195a, the area where the image formation is forbidden also includes the recess P5a formed by the projection 195a. Even in this case, the area where the image formation is forbidden is depends on each sheet. For example, as shown in part (b) of FIG. 14, on the sheet P501 located on the side closest to the cover, the distance to the edge from the center of the area where the image formation is forbidden is set to the forbidden distance N501. As shown in part (a) of FIG. 14, before the flattening is performed by the roller 96, it is assumed that t is a width of the projection 195a, w is a distance between the projection 195a and the surface in which the roller 96 of the clamping jaw 195 is moved, and d3 is a width of a gap between the stop plate 94 (not shown) and the clamping jaw 195. A distance v between the front end of the sheet P520 located on the side opposite to the booklet cover and the front end of the portion P5a corresponding to the spine of the booklet is equal to the thickness of 20 sheets. For example, in the case where the thickness of the booklet is 0.087 mm, the distance v is 0.087×20=1.74 mm. In this case, a half length u of an arc possessed by the portion P5a corresponding to the spine of the booklet is a quarter of a circumference of a circle having a radius of the distance v. Therefore, the length u is u=1.74×2×π/4=2.73 mm. At this point, for example, it is assumed that d3 is 1.5 mm, w is 4 mm, t is 0.3 mm, and the width from the sheet center in the area where the image formation is forbidden, i.e., forbidden distance is N501. Then, N501=u+(d3+w+t−v)=6.79 mm. Similarly to the forbidden distance N501, the forbidden distances N502 to N520 corresponding to other sheets P502 to P520 can be computed from the number of sheets constituting the booklet, the sheet position, and the thickness of the sheets.

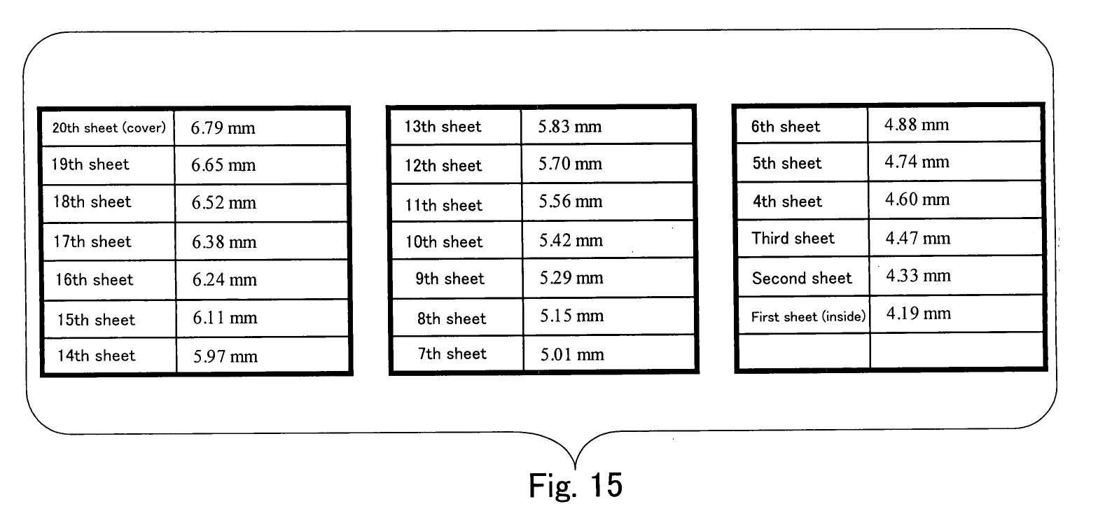

FIG. 15 is a table showing the forbidden distance on each sheet in the fifth embodiment of the invention

FIG. 15 shows the forbidden distances N501 to N520 on each sheet in the case where the 20 sheets are folded while the intensity of the square folding process is set to the strong level. Each of the sheets has the thickness of 0.087 mm. In the table of FIG. 15, the value corresponding to the field of “20th sheet” indicates the forbidden distance M501, and “19th sheet”, “18th sheet”, . . . , and “first sheet” indicate M502, M503, and M520 respectively.

In the fifth embodiment, through the exposure start timing computing process shown in Step S13 of FIG. 10, in consideration of the projection 195a of the clamping jaw 195, the forbidden distance is computed on each sheet position in the booklet.

In the above embodiments, control circuit 26 is incorporated into the image forming apparatus 2. However, the invention is not limited to the above embodiments. For example, the control circuits may be mounted on both the image forming apparatus and the square folding device such that the functions are shared.

In the above embodiments, the forbidden distance is determined based on the information on the number of sheets and the sheet thickness information. However, the invention is not limited to the above embodiments. For example, the forbidden distance may be determined based on either the information on the number of sheets or the sheet thickness information.

In the above embodiments, through the square folding process, the back is pressed by the roller 96 while the clamping jaw 95 clamps the booklet. However, the invention is not limited to the above embodiments. Other modes may be used as the shape of the roller and the way how to move as long as the roller produces the booklet whose back is flattened. Any device which flattens the back may be used instead of the roller.

According to an aspect of the present invention, the edge close to the center of the double pages spread in the image forming area where the image is formed is located away from the center, and the image is formed away from the flattened portion. Also, the flattened portion is enlarged as the sheet is located closer to the booklet cover side. However, in the sheet treatment apparatus of the invention, because the edge in the image forming area is located farther away from the center as the sheet is located closer to the booklet cover side, the image is formed while properly located away from the flattened portion which depends on the sheet position in the booklet. Accordingly, the image disturbance by the flattening is prevented in the back portion of the booklet and the lack of the image is also prevented in the crease, so that the booklet quality can be improved.

The foregoing description of the embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A sheet treatment apparatus comprising:
an image forming unit that forms images on a plurality of sheets;
a booklet producing unit that produces a booklet by laying the plurality of sheets on top of one another and folding the plurality of sheets, the folded back of the booklet being pressed to flatten a spine of the booklet; and
a control unit that controls the image forming unit to form the image in an image forming area of the sheet, in way that the closer the sheet is located to a booklet cover side, the farther an edge of the image forming area which is close to a center of a double pages spread is located away from the center of the double pages spread.

2. A sheet treatment apparatus according to claim 1, wherein the control unit controls the image forming unit to form the image in the image forming area of the sheet, in way that the edge of the image forming area which is close to the center of the double pages spread being located far away from the center of the double pages spread by a distance according to a contraction amount of the back, the contraction amount of the back being the amount that the back of the booklet contracts when the back of the booklet of folded sheets is pressed to flatten the spine of the booklet.

3. A sheet treatment apparatus according to claim 1, wherein the control unit obtains information on the number of sheets indicating the number of sheets constituting the booklet, and the control unit controls the image forming unit to form the image in the image forming area of the sheet, in way that the edge of the image forming area which is close to the center of the double pages spread being located far away from the center of the double pages spread by a distance according to the number of sheets indicated by the obtained information on the number of sheets.

4. A sheet treatment apparatus according to claim 1, wherein the control unit obtains sheet thickness information indicating a thickness of the sheets constituting the booklet, and the control unit controls the image forming unit to form the image in the image forming area of the sheet, in way that the edge of the image forming area which is close to the center of the double pages spread being located far away from the center of the double pages spread by a distance according to the thickness of the sheet indicated by the obtained sheet thickness information.

5. A sheet treatment apparatus according to claim 1, wherein the image forming unit includes a rotating image holding body and an exposure device, the exposure device forming an electrostatic latent image on a surface of the image holding body by scanning the surface of the image holding body with exposure light in a rotating axis direction of the image holding body, the image forming unit develops the electrostatic latent image with toner to obtain a toner image, and the image forming unit finally transfers and fixes the toner image to the sheet to form the fixed toner image on the sheet, and
the control unit determines exposure start timing based on a degree in which the sheet is located on the booklet cover side, the exposure start timing beng the timing when the exposure device starts the formation of the electrostatic latent image, and the control unit controls the exposure device to start the formation of the electrostatic latent image at the exposure start timing.

6. A sheet treatment apparatus according to claim 5, further comprising a sheet conveyance unit that conveys the sheet along a conveyance path through the image forming unit,
wherein the control unit determines conveyance start timing based on a degree in which the sheet is located on the booklet cover side, the conveyance start timing being the timing when the sheet conveyance unit starts the sheet conveyance, and the control unit controls the sheet conveyance unit to start the sheet conveyance at the conveyance start timing.

7. A sheet treatment apparatus according to claim 1, wherein the control unit controls the image forming unit to form the image on the sheet in way that, the closer the sheet of the booklet is located to the booklet cover side, the image having the shorter width in a direction of from an edge to the center of the double pages spread is formed on the sheet by the image forming unit.

8. A sheet treatment apparatus according to claim 7, wherein the control unit determines scanning speed based on a degree in which the sheet is located on the booklet cover side, the scanning speed being the speed of scanning that the exposure device scans the surface of the image holding body with exposure light, and the control unit controls the exposure device to scan the surface of the image holding body with the exposure light at the scanning speed and to form the electrostatic latent image.

9. A sheet treatment apparatus according to claim 7, further comprising a sheet conveyance unit that conveys the sheet along a conveyance path through the image forming unit,
wherein the control unit determines a conveyance speed of the sheet conveyance unit based on a degree in which the sheet is located on the booklet cover side, and the control unit controls the sheet conveyance unit to convey the sheet at the conveyance speed.
